(19) United States
(12) Patent Application Publication
(10) Pub. No.: US 2025/0305828 A1
(43) Pub. Date: Oct. 2, 2025

(54) Vibrator Device

(71) Applicant: SEIKO EPSON CORPORATION, Tokyo (JP)

(72) Inventor: Norifumi SHIMIZU, Matsumoto (JP)

(21) Appl. No.: 19/093,678

(22) Filed: Mar. 28, 2025

(30) Foreign Application Priority Data
Mar. 29, 2024 (JP) 2024-055302

(51) Int. Cl. G01C 19/5783

(52) U.S. Cl. CPC G01C 19/5783

(57) ABSTRACT

The vibrator device includes a vibration element, a support substrate supporting the vibration element, and a base to which the support substrate is attached. The support substrate includes a frame portion, an element mounting portion provided inside the frame portion, on which the vibration element is mounted, and a plurality of beam portions supporting the element mounting portion inside the frame portion. The frame portion includes stress relaxation portions as thin portions, narrow portions, or spring portions.

The present application is based on, and claims priority from JP Application Serial Number 2024-055302, filed Mar. 29, 2024, the disclosure of which is hereby incorporated by reference herein in its entirety.

### BACKGROUND

### 1. Technical Field

The present disclosure relates to a vibrator device.

### 2. Related Art

JP-A-2021-21636 discloses a vibrator device including a vibration element and a support substrate disposed to face the vibration element and supporting the vibration element. The support substrate in JP-A-2021-21636 includes a first supporting portion, a plurality of beam portions extending from the first supporting portion, a second supporting portion, and a plurality of beam portions extending from the second supporting portion.

JP-A-2021-21636 is an example of the related art.

In the support substrate in JP-A-2021-21636, mechanical coupling between the first supporting portion and the second supporting portion is made by the plurality of beam portions via a center base portion. In the structure, it has been found that there is a problem that, for example, stress is concentrated on a base part or the like of the beam portion and rigidity in the beam portion is hard to be secured, and the beam portion is easily flexibly deformed and handling during mounting becomes difficult.

### SUMMARY

An aspect of the present disclosure relates to a vibrator device including a vibration element, a support substrate supporting the vibration element, and a base to which the support substrate is attached, wherein the support substrate includes a frame portion, an element mounting portion provided inside the frame portion, on which the vibration element is mounted, and a plurality of beam portions supporting the element mounting portion inside the frame portion, and the frame portion includes a stress relaxation portion as a thin portion, a narrow portion, or a spring portion.

### BRIEF DESCRIPTION OF THE DRAWINGS

FIG. 1 is a cross-sectional view showing a configuration example of a vibrator device according to an embodiment.

FIG. 2 shows an action of the vibration element.

FIG. 3 is a plan view of a support substrate as seen from a top surface side.

FIG. 4 is a plan view of the support substrate as seen from a bottom surface side.

FIG. 5 is a plan view and a cross-sectional view of the support substrate provided with slits as stress relaxation portions.

FIG. 6 is a plan view and a cross-sectional view of a support substrate of a comparative example.

FIG. 7 is a plan view and a cross-sectional view of the support substrate provided with a slit only in an upper surface as a stress relaxation portion.

FIG. 8 is a plan view and a cross-sectional view of the support substrate provided with a plurality of slits as stress relaxation portions.

FIG. 9 is a plan view and a cross-sectional view of the support substrate provided with narrow portions as stress relaxation portions.

FIG. 10 is a plan view and a cross-sectional view of the support substrate provided with spring portions as stress relaxation portions.

FIG. 11 is a plan view and a cross-sectional view of the support substrate provided with a plurality of spring portions as stress relaxation portions.

FIG. 12 shows an arrangement relationship among the support substrate, the vibration element, and a circuit device.

FIG. 13 shows an arrangement relationship among substrate bonding members and the stress relaxation portions.

### DESCRIPTION OF EMBODIMENTS

As below, an embodiment will be described. The embodiment to be described does not unduly limit the description of the claims. Not all configurations described in the embodiment are essential component elements.

### 1. Vibrator Device

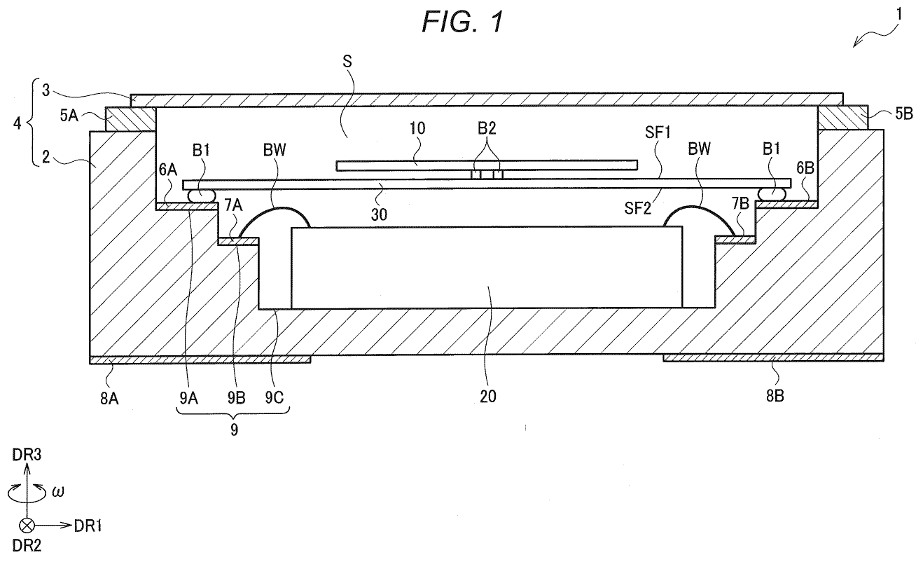

FIG. 1 is a cross-sectional view showing a configuration example of a vibrator device 1 according to the embodiment. As shown in FIG. 1, the vibrator device 1 of the embodiment includes a vibration element 10, a support substrate 30 that supports the vibration element 10, and a base 2 to which the support substrate 30 is attached. The vibrator device 1 may further include a package 4 including a lid 3 and the base 2, and a circuit device 20. Note that the vibrator device 1 is not limited to the configuration of FIG. 1, but various modifications including omission of part of the component elements and addition of other component elements can be made. For example, a modification in which the circuit device 20, the lid 3, and the like are not provided can be made. In the embodiment, as shown in FIG. 1, directions orthogonal to each other are a direction DR1 and a direction DR2, and a direction orthogonal to the direction DR1 and the direction DR2 is a direction DR3. The directions DR1, DR2, and DR3 are a first direction, a second direction, and a third direction, respectively. The pointer side of an arrow in each direction of DR1, DR2, DR3 is also referred to as a plus side, and the opposite side is also referred to as a minus side. FIG. 1 is a side view of the vibrator device 1 as seen in the direction DR2.

The vibration element 10 is, for example, a physical quantity detection element. The physical quantity detection element may be also called, for example, a physical quantity transducer, and is an element for detecting a physical quantity. The physical quantity detection element has a vibrator element, and the physical quantity is detected using the vibration of the vibrator element. For example, when the physical quantity detection element is a gyro sensor element, an angular velocity is detected as the physical quantity. Examples of the gyro sensor element include a sensor element having a piezoelectric vibrator element formed of a thin plate of a piezoelectric material such as quartz crystal. Specifically, the gyro sensor element is a sensor element having a vibrator element of a double T-shape, a tuning fork type, an H type, or the like formed using a quartz crystal substrate of Z cut or the like. Alternatively, a MEMS (Micro Electro Mechanical Systems) sensor element may be used as the gyro sensor element. The physical quantity detected by the physical quantity detection element may be a physical quantity such as an angular acceleration, an angle, an acceleration, a velocity, a travel distance, or pressure other than the angular velocity. The vibration element 10 may be a vibration element of an oscillator. In this case, the oscillator functioning as the vibrator device 1 may be a temperature compensated crystal oscillator (TCXO), an oven equipped crystal oscillator (OCXO), a voltage controlled crystal oscillator (VCXO), a simple packaged crystal oscillator (SPXO) not having temperature compensation function, a SAW (Surface Acoustic Wave) oscillator, a voltage controlled SAW oscillator, a MEMS (Micro Electro Mechanical Systems) oscillator, or the like.

The package 4 includes the base 2 and the lid 3. Specifically, the package 4 includes the base 2 having a recess 9 opening upward, and the lid 3 joined to the upper surface of the base 2 so as to form a housing space S between the base 2 and itself. The base 2 and the lid 3 are bonded by, for example, bonding members 5A and 5B. For example, the base 2 can be formed using ceramic such as alumina, and the lid 3 can be formed using a metal material such as kovar. However, the constituent materials of the base 2 and the lid 3 are not limited thereto.

The housing space S is formed by the opening portion of the base 2 inside the package 4, and the vibration element 10, the support substrate 30, and the circuit device 20 are housed in the housing space S. The housing space S as an internal space is airtight, and is in a reduced pressure state, preferably a state close to a vacuum. This reduces the viscous resistance and improves the vibration characteristics of the vibration element 10. However, the atmosphere of the housing space S is not particularly limited, but may be in, for example, an atmospheric pressure state or a pressurized state. As long as the vibrator device 1 of the embodiment has the base 2, the lid 3 may not be provided.

The recess 9 of the base 2 includes a plurality of recesses. For example, the recess 9 includes a recess 9A that is open to the upper surface of the base 2, a recess 9B that is open to the bottom surface of the recess 9A and has an opening width smaller than that of the recess 9A, and a recess 9C that is open to the bottom surface of the recess 9B and has an opening width smaller than that of the recess 9B. The support substrate 30 is fixed to the bottom surface of the recess 9A with the vibration element 10 supported. The bottom surface of the recess 9A is a stepped portion. The circuit device 20 is fixed to the bottom surface of the recess 9C.

As shown in FIG. 1, in the housing space S, the vibration element 10, the support substrate 30, and the circuit device 20 are placed to overlap in a plan view. For example, the vibration element 10, the support substrate 30, and the circuit device 20 are arranged along the direction DR3. For example, the support substrate 30 has a surface SF1 as a first surface and a surface SF2 as a second surface as principal surfaces thereof. The vibration element 10 is disposed at the surface SF1 side of the support substrate 30. The circuit device 20 is disposed at the surface SF2 of the support substrate 30.

The arrangement of the vibration element 10, the support substrate 30, and the circuit device 20 is not limited to the arrangement in FIG. 1. For example, in FIG. 1, the support substrate 30 is disposed between the vibration element 10 and the circuit device 20, however, the vibration element 10 may be disposed between the support substrate 30 and the circuit device 20. In FIG. 1, the vibration element 10, the support substrate 30, and the circuit device 20 are arranged in this order from the upper surface side of the package 4, however, may be arranged in the order of the circuit device 20, the support substrate 30, and the vibration element 10 from the upper surface side of the package 4.

As shown in FIG. 1, a plurality of internal terminals 6A and 6B are disposed in the step portion of the bottom surface of the recess 9A of the base 2. Further, a plurality of internal terminals 7A and 7B are also disposed in a stepped portion of the bottom surface of the recess 9B of the base 2. Furthermore, a plurality of external terminals 8A and 8B are disposed on the lower surface of the base 2. The internal terminals 6A and 6B, the internal terminals 7A and 7B, and the external terminals 8A and 8B are electrically coupled via internal wires (not shown). The internal terminals 6A and 6B are electrically coupled to the vibration element 10 via conductive bonding members B1 and B2 and the support substrate 30. The internal terminals 7A and 7B are electrically coupled to the circuit device 20 via bonding wires BW.

The conductive bonding members B1 and B2 are members having both conductivity and bonding properties. Although the conductive bonding members B1 and B2 are not particularly limited, but a conductive adhesive in which conductive fillers such as silver fillers are dispersed in various adhesives of polyimide, epoxy, silicone, or acrylic, various metal bumps such as gold bumps, silver bumps, copper bumps, and solder bumps, or the like may be used.

For example, in the embodiment, conductive adhesives are used as the bonding members B1 between the support substrate 30 and the base 2 of the package 4, specifically, a thermosetting adhesive. Further, metal bumps are used as the bonding members B2 between the support substrate 30 and the vibration element 10. The conductive adhesives are used as the bonding members B1 for bonding the base 2 and the support substrate 30 that are formed using different materials, and thereby, thermal stress caused by a difference in thermal expansion coefficient between the materials can be absorbed and relaxed by the bonding members B1. On the other hand, since the support substrate 30 and the vibration element 10 are bonded by the plurality of bonding members B2 disposed in a relatively small area, the metal bumps are used as the bonding members B2, and thereby, wetting and spreading as in the case of the conductive adhesive may be suppressed and contact between the bonding members B2 may be effectively suppressed.

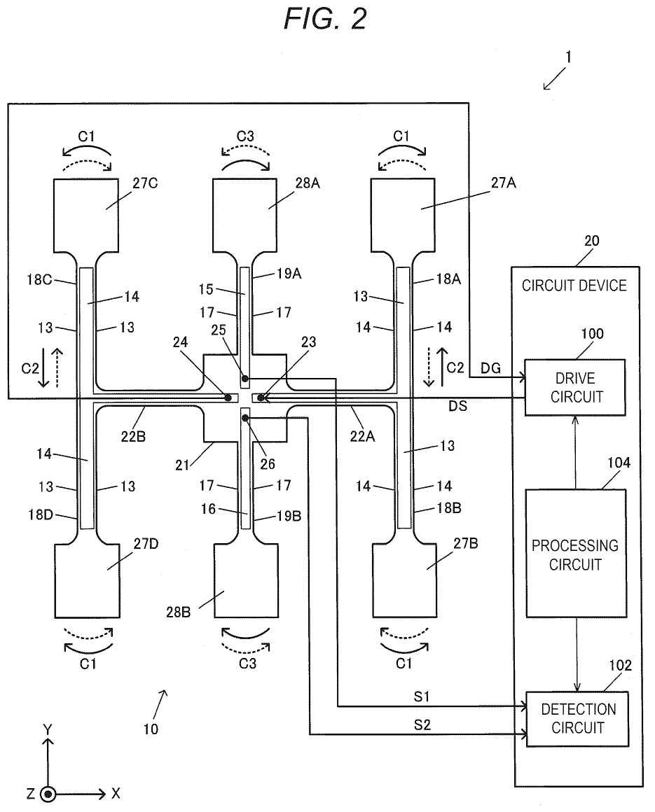

FIG. 2 shows an example of an action of the vibration element 10. In the following description, a case where the vibration element 10 is a gyro sensor element, specifically, a double-T-shaped gyro sensor element will be mainly explained as an example. However, as described above, the vibration element 10 may be a gyro sensor element other than the double T-shape, a physical quantity detection element other than the gyro sensor element, or a vibration element in an oscillator.

For example, when a Z axis is a thickness direction of the vibration element 10, the vibration element 10 as a gyro sensor element detects an angular velocity @ around the Z axis. An X axis and a Y axis are coordinate axes orthogonal to the Z axis, and the X axis and the Y axis are orthogonal to each other. For example, the vibration element 10 is disposed so that the Z axis in FIG. 2 is along the direction DR3 in FIG. 1, and thereby, the angular velocity @ using the axis along the direction DR3 as a detection axis can be detected.

As shown in FIG. 2, the vibrator device 1 includes the vibration element 10 and the circuit device 20. For example, the circuit device 20 is an integrated circuit device called an IC (integrated circuit). For example, the circuit device 20 is an IC manufactured by a semiconductor process and is a semiconductor chip in which a circuit element is formed at a semiconductor substrate. The circuit device 20 includes a drive circuit 100, a detection circuit 102, and a processing circuit 104. A modification in which part of the circuits are not provided can be made.

The vibration element 10 includes drive arms 18A, 18B, 18C, and 18D, detection arms 19A and 19B, a base portion 21, and coupling arms 22A and 22B. The detection arms 19A and 19B extend in a +Y axis direction and a −Y axis direction with respect to the base portion 21 having a rectangular shape. The coupling arms 22A and 22B extend in a +X axis direction and a −X axis direction with respect to the base portion 21. The drive arms 18A and 18B extend in the +Y axis direction and the −Y axis direction from a tip end portion with respect to the coupling arm 22A, and the drive arms 18C and 18D extend in the +Y axis direction and the −Y axis direction from a tip end portion with respect to the coupling arm 22B.

The vibration element 10 includes weight portions 27A, 27B, 27C, 27D, 28A, and 28B. The weight portion is also called a hammer head portion. The weight portions 27A and 27B are provided at the tip end sides of the drive arms 18A and 18B, respectively, and the weight portions 27C and 27D are provided at the tip end sides of the drive arms 18C and 18D, respectively. The weight portions 28A and 28B are provided at the tip end sides of the detection arms 19A and 19B, respectively. The weight portions 27A, 27B, 27C, 27D provided at the drive arms 18A, 18B, 18C, 18D are balance adjustment portions, and are used for balance adjustment of the vibration of the vibration element 10. For example, when the vibrator device 1 is manufactured, the balance adjustment of the vibration of the vibration element 10 is performed by trimming of the metal of the weight portions 27A, 27B, 27C, 27D by laser.

The vibrator element of the vibration element 10 can be formed using a piezoelectric material such as quartz crystal, lithium tantalate or lithium niobate. Of the materials, it is preferable to use the quartz crystal as the constituent material of the vibrator element. The X axis, the Y axis, and the Z axis are also referred to as an electrical axis, a mechanical axis, and an optical axis of the quartz crystal substrate, respectively. The quartz crystal substrate is formed using a plate-like Z cut quartz crystal plate having a thickness in the Z-axis direction or the like.

Drive electrodes 13 are formed at the upper surfaces and the lower surfaces of the drive arms 18A and 18B, and drive electrodes 14 are formed at the right side surfaces and the left side surfaces of the drive arms 18A and 18B. Drive electrodes 14 are formed at the upper surfaces and the lower surfaces of the drive arms 18C, 18D, and drive electrodes 13 are formed at the right side surfaces and the left side surfaces of the drive arms 18C, 18D. A drive signal DS from the drive circuit 100 is supplied to the drive electrodes 13, and a feedback signal DG from the drive electrodes 14 is input to the drive circuit 100.

Detection electrodes 15 are formed at the upper surface and the lower surface of the detection arm 19A, and ground electrodes 17 are formed at the right side surface and the left side surface of the detection arm 19A. Detection electrodes 16 are formed at the upper surface and the lower surface of the detection arm 19B, and ground electrodes 17 are formed at the right side surface and the left side surface of the detection arm 19B. The ground electrodes 17 are grounded, for example. Detection signals S1 and S2 from the detection electrodes 15 and 16 are then input to a detection circuit 102.

Grooves (not shown) for improving the electric field effect between the electrodes are provided on the upper surfaces and the lower surfaces of the drive arms 18A, 18B, 18C, 18D and the detection arms 19A, 19B. The grooves are provided, and thereby, a comparatively large amount of electric charge can be generated with a relatively small amount of distortion. The upper surface is a surface at the +Z axis direction side (the positive direction side of the Z axis), and the lower surface is a surface at the −Z axis direction side (the negative direction side of the Z-axis). The right side surface is a side surface at the +X axis direction side (the positive direction side of the X axis), and the left side surface is a side surface at the −X axis direction side (the negative direction side of the X axis).

The base portion 21 is provided with driving terminals 23 and 24 and detection terminals 25 and 26. The drive signal DS from the drive circuit 100 is input to the driving terminal 23, and the feedback signal DG to the drive circuit 100 is output from the driving terminal 24. The detection signal S1 to the detection circuit 102 is output from the detection terminal 25, and the detection signal S2 to the detection circuit 102 is output from the detection terminal 26.

The drive circuit 100 provided in the circuit device 20 is a circuit that drives the vibration element 10. The drive circuit 100 outputs the drive signal DS to the vibration element 10 to vibrate the vibrator element of the vibration element 10. The drive signal DS is, for example, a rectangular wave signal, but may be a sine wave signal.

The detection circuit 102 detects the physical quantity based on the detection signals S1 and S2 from the vibration element 10. In FIG. 2, an angular velocity is detected as the physical quantity. The detection signals S1 and S2 are detection signals of a physical quantity with a drive frequency of the drive signal DS as a carrier frequency, for example. The detection circuit 102 detects the physical quantity (angular velocity) in the detection signals S1 and S2 by, for example, synchronous detection using a synchronization signal of a signal based on the detection signals S1 and S2, and outputs detection data.

The processing circuit 104 is a circuit that performs processing such as digital signal processing on the detection data from the detection circuit 102. The processing circuit 104 performs digital signal processing including digital filter processing on the detection data from the detection circuit 102. The detection data after the digital filter processing by the processing circuit 104 is output as a final detection value of the physical quantity, for example. Note that the signal processing executed by the processing circuit 104 is not limited to the digital filter processing, but various kinds of signal processing including, for example, temperature compensation processing and various kinds of correction processing can be executed.

Next, a detailed action when the vibration element 10 is a gyro sensor element will be described. When the drive signal DS is applied to the drive electrodes 13 from the drive circuit 100, the drive arms 18A, 18B, 18C, 18D perform the flexural vibration as indicated by arrows C1 in FIG. 2 due to the inverse piezoelectric effect. For example, a vibration mode shown by solid arrows and a vibration mode shown by dotted arrows are repeated at a predetermined frequency. That is, the flexural vibration is performed in which tip ends of the drive arms 18A and 18C repeat movement closer to and away from each other and tip ends of the drive arms 18B and 18D repeat movement closer to and away from each other. Here, the drive arms 18A and 18B and the drive arms 18C and 18D vibrate line-symmetrically with respect to the X axis passing through the center of gravity of the base portion 21, and the base portion 21, the coupling arms 22A, 22B, and the detection arms 19A, 19B vibrate little.

In this state, when an angular velocity around the Z axis as a rotation axis is applied to the vibration element 10, the drive arms 18A, 18B, 18C, and 18D vibrate as indicated by arrows C2 due to the Coriolis force. That is, the Coriolis force in the direction of the arrows C2 orthogonal to the direction of the arrow C1 and the direction of the Z axis acts on the drive arms 18A, 18B, 18C, and 18D, and thereby, a vibration component in the direction of the arrows C2 is generated. The vibration indicated by the arrows C2 is transmitted to the base portion 21 via the coupling arms 22A and 22B, and the detection arms 19A and 19B perform the flexural vibration in the direction indicated by arrows C3. Electric charge signals generated due to the piezoelectric effect caused by the flexural vibration of the detection arms 19A and 19B are input as the detection signals S1 and S2 to the detection circuit 102, and thereby, the angular velocity around the Z axis is detected.

For example, when the angular velocity of the vibration element 10 around the Z axis is ω, a mass is m, and a vibration velocity is v, the Coriolis force is expressed by Fc=2 m·v·ω. Accordingly, the angular velocity ω around the Z axis can be obtained by the detection circuit 102 detecting a desired signal that is a signal according to the Coriolis force.

### 2. Support Substrate

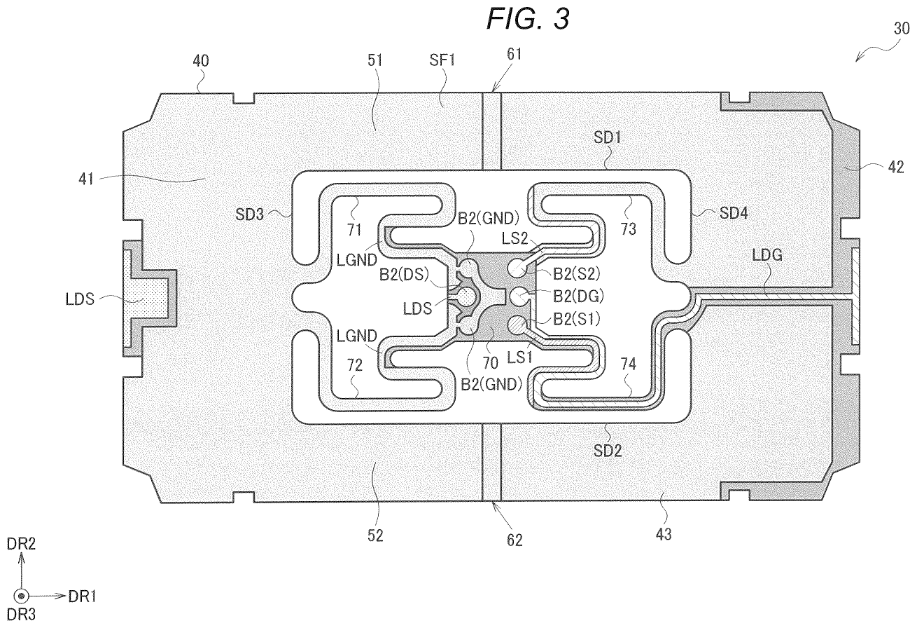

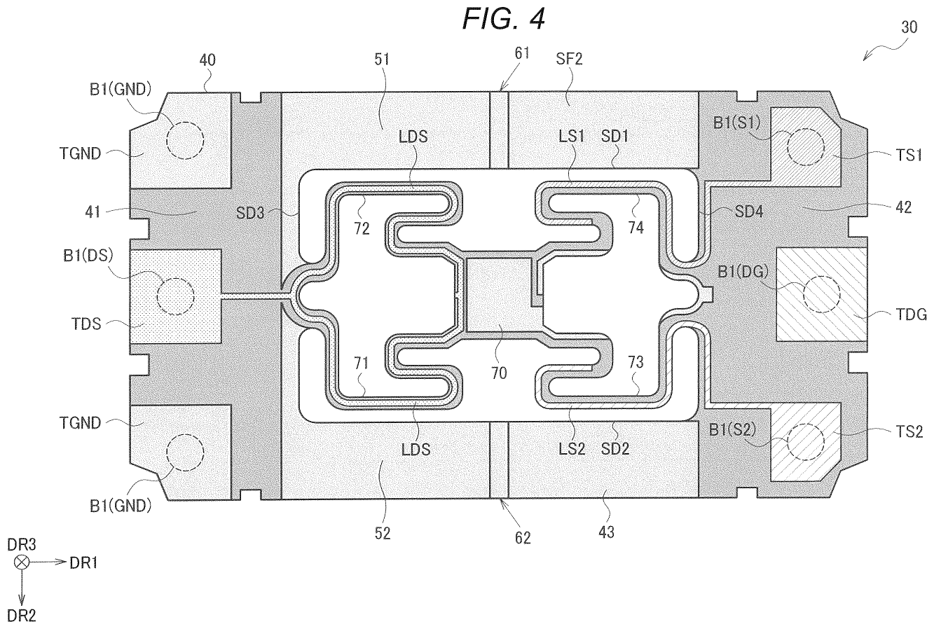

Next, the support substrate 30 of the embodiment will be described in detail. FIGS. 3 and 4 show a configuration example of the support substrate 30. The support substrate 30 is also called a relay substrate, and is, for example, a plate-shaped substrate having the surface SF1 as the first surface and the surface SF2 as the second surface. FIG. 3 is a plan view of the support substrate 30 as seen from the surface SF1 side, and FIG. 4 is a plan view of the support substrate 30 as seen from the surface SF2 side. In the embodiment, the surface SF1 is the upper surface of the support substrate 30, and the surface SF2 is the lower surface of the support substrate 30. In FIGS. 3 and 4, the direction DR1 as the first direction is, for example, a direction along the long side of the support substrate 30, and the direction DR2 as the second direction is, for example, a direction along the short side of the support substrate 30. The direction DR1 and the direction DR2 are directions orthogonal to each other. The direction DR3 as the third direction is a direction orthogonal to the direction DR1 and the direction DR2. For example, the direction DR3 is a direction orthogonal to the surfaces SF1 and SF2 of the support substrate 30. The term “orthogonal” includes substantially orthogonal. For example, when the vibrator device 1 is a gyro sensor element, the angular velocity @ about the axis in the direction DR3 is detected.

As shown in FIGS. 3 and 4, the support substrate 30 includes a frame portion 40, an element mounting portion 70, and a plurality of beam portions 71, 72, 73, and 74. The element mounting portion 70 is provided inside the frame portion 40, and the vibration element 10 is mounted thereon. The beam portions 71, 72, 73, and 74 support the element mounting portion 70 inside the frame portion 40. Note that the support substrate 30 is not limited to the configuration in FIGS. 3 and 4, but various modifications including omission of part of the component elements and addition of other component elements can be made.

The support substrate 30 is formed using, for example, a quartz crystal substrate. The support substrate 30 is formed using the quartz crystal substrate, and thereby, fluctuations of the resonance frequency of the support substrate 30 due to the temperature can be reduced as compared with a case of using a support member formed using, for example, a joined material of a polyimide film and a copper foil. As a result, generation of unnecessary vibration in the vibration element 10 due to the vibration caused at the resonance frequency of the support substrate 30 can be suppressed. The support substrate 30 is formed using, for example, a substrate of the same material as the vibration element 10. For example, when the vibration element 10 is formed using a quartz crystal substrate, the support substrate 30 is also formed using the same quartz crystal substrate. The support substrate 30 is formed using the same quartz crystal substrate as the vibration element 10, and thereby, the thermal expansion coefficients of the support substrate 30 and the vibration element 10 can be made substantially equal. Therefore, thermal stress due to the difference in thermal expansion coefficient between the support substrate 30 and the vibration element 10 does not substantially occur, and for example, separation of the bonding members B2 between the support substrate 30 and the vibration element 10 due to thermal stress or the like can be prevented. In addition, the vibration element 10 is less likely to be subjected to stress, and the reduction and variations of vibration characteristics of the vibration element 10 can be suppressed more effectively.

For example, the support substrate 30 is formed using a quartz crystal substrate having the same cut angle as the vibration element 10. For example, when the vibration element 10 is formed using a Z cut quartz crystal substrate, the support substrate 30 is also formed using a Z cut quartz crystal substrate. The orientation of the crystal axis of the support substrate 30 coincides with the orientation of the crystal axis of the substrate of the vibration element 10. That is, the X axes coincide, the Y axes coincide, and the Z axes coincide with respect to the support substrate 30 and the vibration element 10. Since the quartz crystal has different thermal expansion coefficients in the X axis direction, the Y axis direction, and the Z axis direction, the support substrate 30 and the substrate of the vibration element 10 having the same cut angle are used and the orientations of the crystal axes are aligned with each other, and thereby, the above described thermal stress is less likely to occur between the support substrate 30 and the vibration element 10. Thereby, separation of the bonding members B2, deterioration of vibration characteristics, and the like due to thermal stress can be further suppressed.

Note that the support substrate 30 is not limited to the above described configuration. For example, the support substrate may have the same cut angle as the substrate of the vibration element 10, but the orientations of the crystal axes may be different. Or, the support substrate 30 may be formed using a quartz crystal substrate having a cut angle different from that of the substrate of the vibration element 10. Or, the support substrate 30 is not necessarily formed using a quartz crystal substrate. In this case, it is preferable that the constituent material of the support substrate 30 is a material in which a difference in thermal expansion coefficient from the quartz crystal is smaller than a difference in thermal expansion coefficient between the quartz crystal and the constituent material of the base 2.

As shown in FIGS. 3 and 4, the support substrate 30 of the embodiment includes the frame portion 40. The frame portion 40 is a frame-shaped member in which an inner region thereof is formed so as to surround the element mounting portion 70. For example, the frame portion 40 is a frame-shaped member having a shape that surrounds the element mounting portion 70 by a plurality of inner peripheries thereof. For example, in FIGS. 3 and 4, the element mounting portion 70 is surrounded by four inner peripheries SD1, SD2, SD3, and SD4, however, for example, a modification to surround the portion by three inner peripheries or five or more inner peripheries can be made.

Specifically, the frame portion 40 of the support substrate 30 includes supporting portions 41 and 42 and coupling portions 51 and 52. The supporting portion 41 is a first supporting portion, and the supporting portion 42 is a second supporting portion. The coupling portion 51 is a first coupling portion, and the coupling portion 52 is a second coupling portion.

For example, the supporting portion 41 as the first supporting portion is attached to the base 2. The supporting portion 42 as the second supporting portion faces the supporting portion 41 and is attached to the base 2. For example, as shown in FIGS. 3 and 4, the supporting portion 41 and the supporting portion 42 face each other in the direction DR1. As shown in FIG. 1, the supporting portions 41 and 42 are bonded and attached to the base 2 by the bonding members B1. Specifically, the supporting portions 41 and 42 are bonded and attached to the step portion of the recess 9A of the base 2 by the bonding members B1 that are realized by the conductive adhesives. For example, the bonding by the bonding members B1 is realized by applying conductive adhesives, which are realized by thermosetting adhesives such as silver paste, to the internal terminals 6A and 6B in FIG. 1 and bonding the supporting portions 41 and 42 of the support substrate 30.

The coupling portions 51 and 52 couple the supporting portion 41 as the first supporting portion and the supporting portion 42 as the second supporting portion. For example, the coupling portion 51 as the first coupling portion couples the supporting portion 41 and the supporting portion 42 at upside in FIG. 3, and the coupling portion 52 as the second coupling portion couples the supporting portion 41 and the supporting portion 42 at the downside in FIG. 3. The region surrounded by the supporting portions 41 and 42 and the coupling portions 51 and 52 is the inner region of the frame portion 40, and the element mounting portion 70 is provided in the inner region. In the embodiment, stress relaxation portions 61 and 62, which will be described in detail later, are provided on the coupling portions 51 and 52. Although the number of the coupling portions is two in FIGS. 3 and 4, the number of the coupling portions may be one, three, or more.

The beam portions 71, 72, 73, and 74 support the element mounting portion 70 in the inner region of the frame portion 40. The beam portions 71, 72, 73, and 74 may be referred to as spring portions. For example, the beam portions 71 and 72 extend in the direction DR1 from the supporting portion 41 of the frame portion 40. The beam portions 73 and 74 extend from the supporting portion 42 of the frame portion 40 in a direction opposite to the direction DR1. In FIGS. 3 and 4, the case where the four beam portions 71, 72, 73, and 74 are provided as the plurality of beam portions is shown, however, the embodiment is not limited to that. The number of beam portions may be two, three, five, or more. For example, a modification in which only the beam portions 71 and 73 may be provided or only the beam portions 72 and 74 may be provided as the plurality of beam portions can be made.

As shown in FIGS. 3 and 4, each of the beam portions 71, 72, 73, and 74 has a part meandering in an S-shape in the middle thereof, and has a shape that is easily elastically deformed in the directions DR1, DR2, and DR3. Since the beam portions 71 to 74 are deformed in the directions DR1, DR2, and DR3, the stress transferred from the base 2 can be effectively absorbed and relaxed. For example, the beam portions 71 to 74 are meandered in the S-shapes and can be made longer, and thereby, stress and strain can be absorbed by the flexible deformation of the beam portions 71 to 74. In addition, mechanical impacts such as a drop impact and a vibration impact to the vibrator device 1 can be similarly absorbed, and the stress, distortion, mechanical impact, and the like generated in the vibration element 10 can be reduced. Note that the shape of each of the beam portions 71 to 74 is not particularly limited, but may be a straight shape without the meandering part, for example. Further, at least one of the beam portions 71 to 74 may be different in shape from the others.

The vibration element 10 is attached to and mounted on the element mounting portion 70 supported by the beam portions 71 to 74. For example, the vibration element 10 is attached to the element mounting portion 70 by fixation of the base portion 21 of the vibration element 10 in FIG. 2 via the conductive bonding members B2 in FIG. 3. For example, each terminal of the driving terminal and the detection terminal provided on the base portion 21 of the vibration element 10 is bonded to each of the bonding members B2 shown in FIG. 3. For example, a terminal for the drive signal DS provided on the base portion 21 of the vibration element 10 is bonded to the bonding member B2 for DS disposed at the left side of the element mounting portion 70 in FIG. 3. A terminal for the feedback signal DG, a terminal for the detection signal S1, and a terminal for the detection signal S2 provided on the base portion 21 of the vibration element 10 are respectively bonded to the bonding members B2 for DG, S1, and S2 disposed at the right side of the element mounting portion 70 in FIG. 3.

As shown in FIGS. 3 and 4, wires LDS, LDG, LS1, LS2, LGND for DS, DG, S1, S2, and GND are wired on the support substrate 30. As shown in FIG. 4, terminals TDS, TDG, TS1, TS2, and TGND for DS, DG, S1, S2, and GND are provided on, for example, the surface SF2 as the lower surface of the support substrate 30. Metal films 43 set at a potential of GND are formed on the upper surface and the lower surface of the support substrate 30, and the wires LGND for GND are formed using the metal films 43. Note that GND is a potential of a low-potential-side power supply, and may be also referred to as VSS.

For example, the wires LDS for DS have one ends coupled to the bonding member B2 for DS as shown in FIG. 3, are routed in the support substrate 30, and have the other ends coupled to the terminal TDS for DS as shown in FIG. 4. Further, the wire LDG for DG has one end coupled to the bonding member B2 for DG as shown in FIG. 3, is routed in the support substrate 30, and has the other end coupled to the terminal TDG for DG as shown in FIG. 4. Further, the wires LS1 and LS2 for S1 and S2 have one ends coupled to the bonding members B2 for S1 and S2 as shown in FIG. 3, are routed in the supporting substrate 30, and have the other ends coupled to the terminals TS1 and TS2 for S1 and S2 as shown in FIG. 4. Furthermore, the wires LGND for GND have one ends coupled to the bonding members B2 for GND as shown in FIG. 3, are routed in the support substrate 30, and have the other ends coupled to the terminals TGND for GND as shown in FIG. 4.

The terminals TDS, TDG, TS1, TS2, and TGND for DS, DG, S1, S2, and GND are coupled to the internal terminals 6A and 6B provided in the stepped portion of the recess 9A in FIG. 1 via the bonding members B1 for DS, DG, S1, S2, and GND. As described above, the internal terminals 6A and 6B and the internal terminals 7A and 7B are coupled via internal wires (not shown), and the internal terminals 7A and 7B are coupled to the circuit device 20 by the bonding wires BW. Thereby, the drive signal DS, the feedback signal DG, and the detection signals S1 and S2 can be transmitted between the vibration element 10 and the circuit device 20 via the support substrate 30. As described above, the support substrate 30 also functions as a relay substrate that relays signals. The terminal TGND for GND of the support substrate 30 is coupled to the GND terminal (pad) of the circuit device 20 and coupled to an external terminal for GND provided as the external terminals 8A and 8B in FIG. 1.

### 3. Stress Relaxation Portions

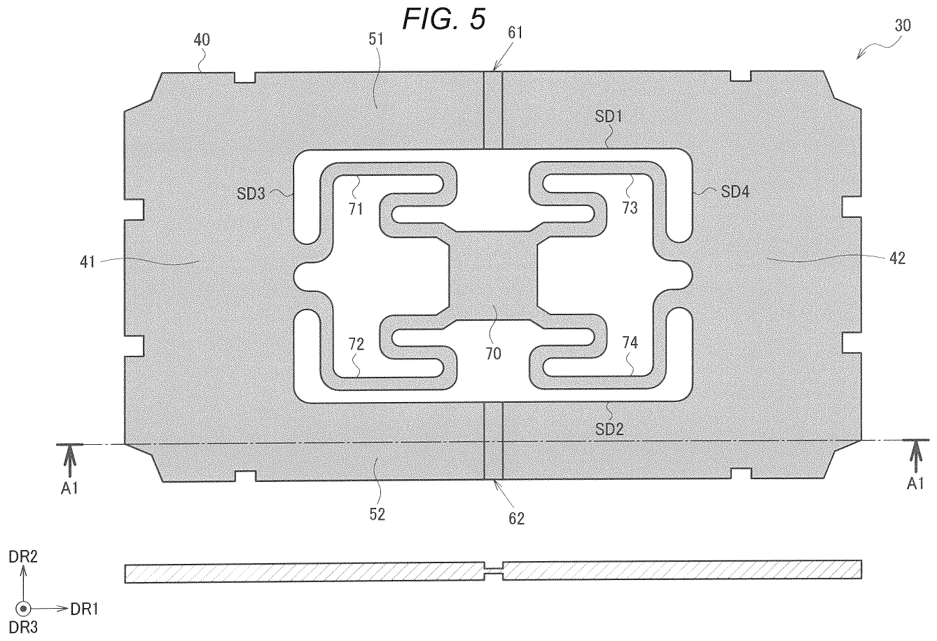

In the embodiment, as shown in FIGS. 3 and 4, the stress relaxation portions 61 and 62 are provided in the frame portion 40 of the support substrate 30. The stress relaxation portion 61 is a first stress relaxation portion, and the stress relaxation portion 62 is a second stress relaxation portion. The stress relaxation portions 61 and 62 are realized by, for example, thin portions, narrow portions, spring portions, or the like. The number of the stress relaxation portions is not limited to two, but may be one, three, or more. As below, the stress relaxation portions 61 and 62 will be described in detail with reference to FIGS. 5 to 13. In FIGS. 5 to 13, plan views of the support substrate 30 in a plan view in the direction DR3 and cross-sectional views cut along line A1 are shown. In the embodiment, the shape of the support substrate 30 is simplified, and dimensions, shapes, and the like are not limited thereto.

For example, as a technique of a first comparative example of the embodiment, there is a technique of using a support member formed using a joined material of a polyimide film and a copper foil as a member supporting the vibration element 10. However, in the support member of the polyimide film, the resonance frequency greatly fluctuates due to a temperature change, and a situation in which the resonance frequency is superimposed on a vibration frequency (drive frequency) of 50 KHz or the like of the vibration element 10 may occur. When the situation occurs, unnecessary vibration is generated in the vibration element 10, an unnecessary signal due to the unnecessary vibration is detected, and the detection accuracy of the physical quantity such as the angular velocity is deteriorated.

In this regard, the support substrate 30 of the embodiment is formed using a substrate such as a quartz crystal substrate in which fluctuations of the resonance frequency due to the temperature are smaller than those of the support member of the polyimide film. Accordingly, the fluctuations of the resonance frequency of the support substrate 30 due to temperature changes may be reduced, and generation of unnecessary vibration in the vibration element 10 caused by the vibration due to the resonance frequency of the support substrate 30 can be suppressed. Further, when the vibration element 10 is formed using a quartz crystal substrate, the support substrate 30 is formed using the same quartz crystal substrate, and thereby, the support substrate 30 and the vibration element 10 can be made equal in thermal expansion coefficient. As a result, the occurrence of a failure, deterioration of the detection accuracy, or the like caused by the thermal stress due to the difference in thermal expansion coefficient can be prevented.

As a technique of a second comparative example of the embodiment, there is a technique of using a support substrate without a frame portion, for example, as in the above described related art of JP-A-2021-21636. In the technique of the second comparative example, the first supporting portion and the second supporting portion are provided separately from each other as support substrates, the first supporting portion is fixed to a first step portion at the left side of the recess 9A in FIG. 1 and the second supporting portion is fixed to a second step portion at the right side of the recess 9A. The element mounting portion is supported by a plurality of beam portions extending from the first supporting portion toward the center and a plurality of beam portions extending from the second supporting portion toward the center.

However, in the technique of the second comparative example, the rigidity in the parts of the beam portions is insufficient. For example, when stress to pull the support substrate toward both sides or the like is generated as will be described later, excessive stress may be applied to the beam portions and a failure may occur. Further, at mounting of the support substrate on the package, the beam portions are easily flexibly deformed and handling at mounting is difficult. In the second comparative example, since there is no coupling portion in the frame portion, for example, when the weight portion as the balance adjustment portion described in FIG. 2 is trimmed by the laser, a situation in which the laser is applied to the circuit device below may occur.

In this regard, as shown in FIG. 5, the support substrate 30 of the embodiment has the frame portion 40. The element mounting portion 70 on which the vibration element 10 is mounted is provided inside the frame portion 40, and the plurality of beam portions 71 to 74 support the element mounting portion 70 inside the frame portion 40.

According to the support substrate 30 having the above described configuration, since the beam portions 71 to 74 are provided in the inner region of the frame portion 40, the frame portion 40 serves as a reinforcing member to ensure the rigidity in the parts of the beam portions 71 to 74 and occurrence of a failure due to excessive stress applied to the beam portions 71 to 74 can be suppressed. For example, the coupling portion 51 of the frame portion 40 is provided at the direction DR2 side of the beam portions 71 to 74, and the coupling portion 52 of the frame portion 40 is provided at the opposite direction side to DR2 of the beam portions 71 to 74. Accordingly, the stress applied to the support substrate 30 is dispersed in the coupling portions 51 and 52, and application of excessive stress to the beam portions 71 to 74 can be suppressed. Even when the beam portions 71 to 74 have structures that are easily flexibly deformed, the rigidity of the support substrate 30 is ensured by the coupling portions 51 and 52 of the frame portion 40 and handling at mounting is easier. When the weight portion as the balance adjustment portion in FIG. 2 is trimmed by the laser or the like, for example, the coupling portions 51 and 52 of the frame portion 40 serve as barriers and occurrence of a situation in which the laser is applied to the circuit device 20 or the like below can be prevented.

On the other hand, it has been found that a problem, which will be described later, occurs when the support substrate 30 having the configuration as shown in FIG. 5 is used. For example, as shown in FIGS. 1 and 4, the support substrate 30 and the base 2 are bonded using the bonding members B1 of the thermosetting adhesive such as silver paste. For example, the thermosetting adhesive is heated in a furnace and cured and, when returning from a high temperature to the normal temperature after thermal curing, the base 2 and the support substrate 30 shrink at shrinkage rates corresponding to the respective thermal expansion coefficients. In this case, the thermal expansion coefficient of the support substrate 30 is larger than the thermal expansion coefficient of the base 2. For example, the thermal expansion coefficient of alumina as ceramic forming the base 2 is about 6.9 to 7.5 [ppm/° C.], and the thermal expansion coefficient of quartz crystal is about 13.37 [ppm/° C.] in the C-axis normal direction. Accordingly, when returning from the high temperature to the normal temperature, the support substrate 30 shrinks more than the base 2. In FIG. 1, the supporting portion 41 of the support substrate 30 is bonded by the bonding members B1 and fixed to the first step portion at the left side of the recess 9A, and the supporting portion 42 is bonded by the bonding members B1 and fixed to the second step portion at the right side of the recess 9A. Accordingly, when returning from the high temperature to the normal temperature, high stress to pull the support substrate 30 toward both sides is generated. Then, when the tensile stress acts on the support substrate 30, stress may be concentrated on a part with lower rigidity and a failure may occur.

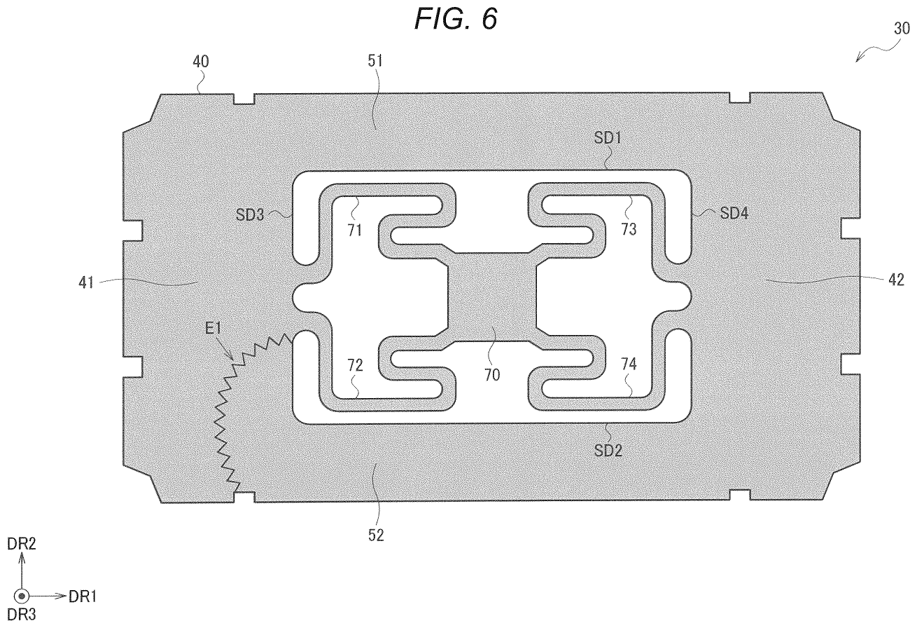

For example, FIG. 6 shows an example of the support substrate 30 without the stress relaxation portion. In the support substrate 30, for example, stress is concentrated on a base part of the beam portion 72 and a cracking failure due to a crack as indicated by E1 occurs. For example, in the polyimide film of the first comparative example as an elastic member or a ductile member, the cracking as indicated by E1 does not occur, however, in the support substrate 30 as a brittle member, the stress generated in the support substrate 30 is less likely to be relaxed by deformation, and therefore, the cracking as indicated by E1 occurs. When the failure occurs, problems such as a decrease in reliability and an adverse effect on the vibration characteristics of the vibration element 10 may occur.

On this account, in the embodiment, in the support substrate 30 having the frame portion 40, the element mounting part 70, and the beam portions 71 to 74 as shown in FIG. 5, the configuration in which the stress relaxation portions 61 and 62 are provided in the frame portion 40 is employed. Specifically, for example, the stress relaxation portions 61 and 62 are provided in the coupling portions 51 and 52 of the frame portion 40. The stress relaxation portions 61 and 62 are, for example, thin portions, narrow portions, or spring portions.

In FIG. 5, slits as thin portions are provided as the stress relaxation portions 61 and 62. For example, the thin portion has a smaller thickness in the out-of-plane direction of the support substrate 30. The out-of-plane direction is a direction orthogonal to the principal surface of the support substrate 30, for example, the direction of DR3. The out-of-plane direction may also be referred to as a thickness direction of the support substrate 30. In FIG. 5, the slits provided as the stress relaxation portions 61 and 62 have smaller thicknesses in the direction DR3 as the out-of-plane direction of the support substrate 30. The slits are provided as the stress relaxation portions 61 and 62, and thereby, for example, even when stress due to a difference in thermal expansion coefficient between base 2 and itself is generated in the support substrate 30, stress acting on the respective parts of the support substrate 30 can be relaxed by, for example, deformation or the like of the support substrate 30 in the parts of the slits. That is, the deformable parts are provided in the support substrate 30, and thereby, stress in the other parts can be relaxed. For example, since the stress acting on the support substrate 30 is dispersed, stress concentration on the base parts of the beam portions 71 to 74 or the like can be suppressed and occurrence of a failure of cracking as indicated by E1 in FIG. 6 can be suppressed.

The thicknesses of the thin portions of the stress relaxation portions 61 and 62 in the direction DR3 are, for example, about ⅕ to ⅘ of the thickness of the support substrate 30 in the direction DR3. The thickness of the support substrate 30 is, for example, about 80 μm to 120 μm. The smaller the thickness of the thin portion, the more easily the support substrate 30 is deformed and the more effectively the stress can be relaxed. When the thickness of the thin portion is too small, a problem of a decrease of the strength of the support substrate 30 may occur.

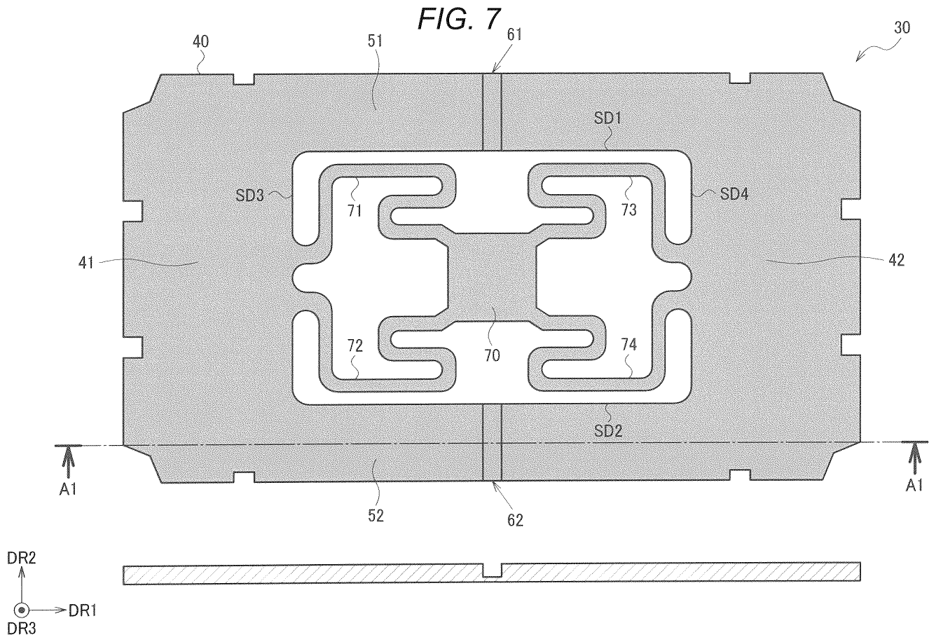

FIG. 7 shows an example in which slits as engraved portions are provided only in the upper surface of the support substrate 30 as the stress relaxation portions 61 and 62. The slits only at the upper surface side as shown in FIG. 7 can be easily formed by, for example, half etching for etching the upper surface in the manufacturing process of the support substrate 30. In this case, the depths of the slits as the thin portions (the thicknesses of the thin portions) of the stress relaxation portions 61 and 62 can be controlled by the amount of etching of the half etching for forming the slits. The slits as shown in FIG. 7 are provided, and thereby, when stress due to a difference in thermal expansion coefficient from the base 2 is generated, the support substrate 30 is deformed into a downwardly concave shape, for example, and the stress is relaxed. When the substrate is deformed into a downwardly concave shape, the vibration element 10 and the support substrate 30 are separated from each other, the parasitic capacitance between the vibration element 10 and the support substrate 30 can be reduced. Thereby, for example, deterioration of detection accuracy due to electrostatic leakage caused by the electrostatic capacitance can be prevented.

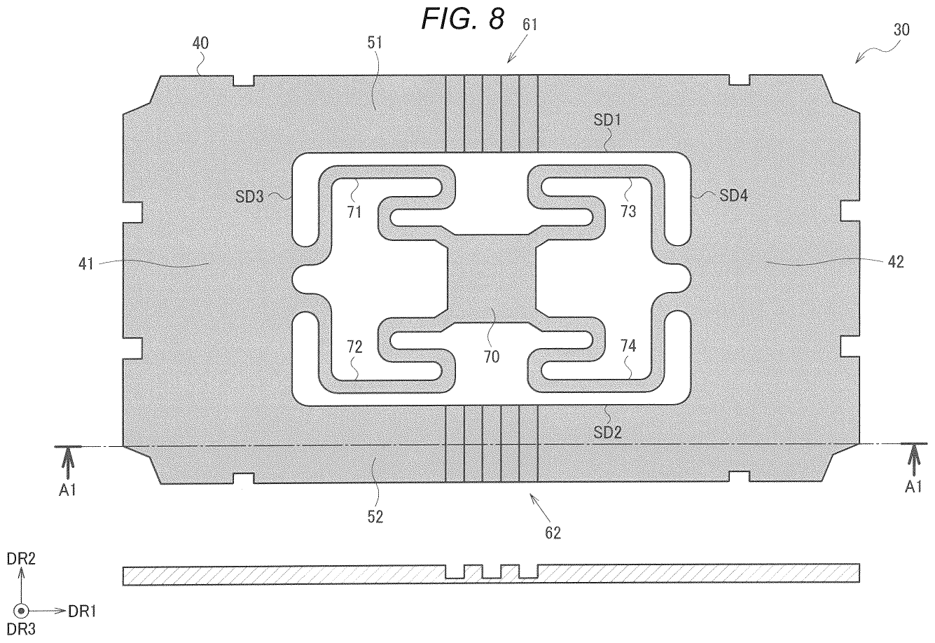

FIG. 8 shows an example in which a plurality of slits are provided as the stress relaxation portions 61 and 62. For example, in FIG. 8, a plurality of slits are provided along the direction DR1 as the long side direction of the support substrate 30. As described above, a plurality of slits are provided in each of the coupling parts of the coupling portions 51 and 52 as the stress relaxation portions 61 and 62, and thereby, the support substrate 30 is more easily deformed when stress acts thereon as compared with a case where one slit is provided in each coupling part as shown in FIG. 5. Accordingly, stress acting on each part of the support substrate 30 can be further reduced and relaxed as compared with that in FIG. 5.

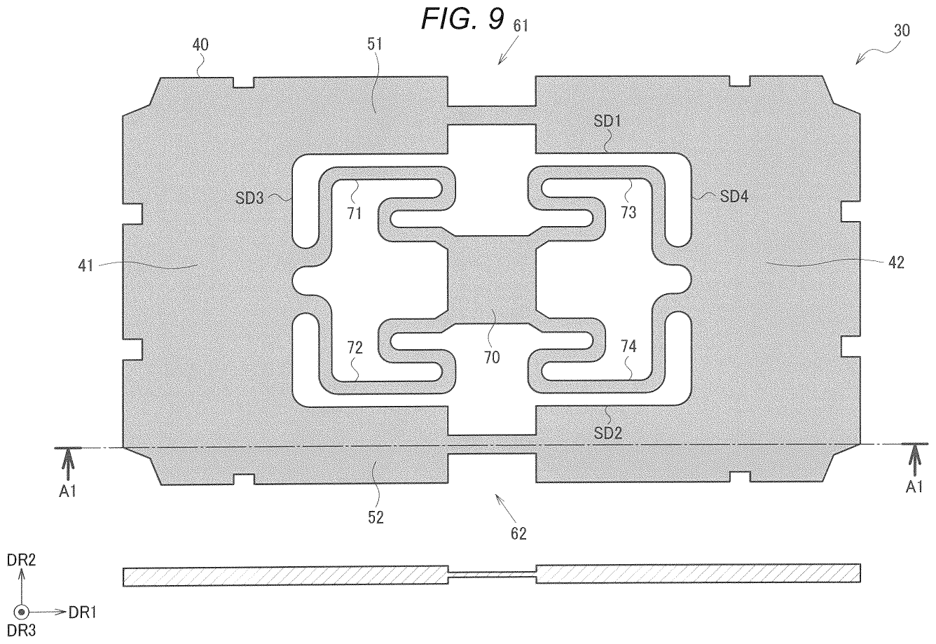

FIG. 9 shows an example in which narrow portions are provided as the stress relaxation portions 61 and 62. The narrow portion is, for example, a portion having a narrow width in the in-plane direction of the support substrate 30. The in-plane direction is a direction along the principal surface of the support substrate 30, for example, the direction of DR2. For example, in FIG. 9, narrow portions having narrow widths in the direction DR2 as the in-plane direction are provided as the stress relaxation portions 61 and 62. The narrow portion may be referred to as a constricted portion in the in-plane direction. Further, as can be seen from the cross-sectional view of the support substrate 30 cut along the line A1, the stress relaxation portions 61 and 62 in FIG. 9 are also thin portions having small thicknesses in the direction DR3. According to the stress relaxation portions 61 and 62 as shown in FIG. 9, for example, as compared with the stress relaxation portions 61 and 62 as shown in FIG. 5 and the like, the support substrate 30 is more easily deformed when stress acts thereon, and stress acting on each part of the support substrate 30 can be further relaxed. For example, the widths of the narrow portions of the stress relaxation portions 61 and 62 in the direction DR2 are about ⅕ to ⅘ of the widths of the coupling portions 51 and 52 of the support substrate 30 in the direction DR2 as an example.

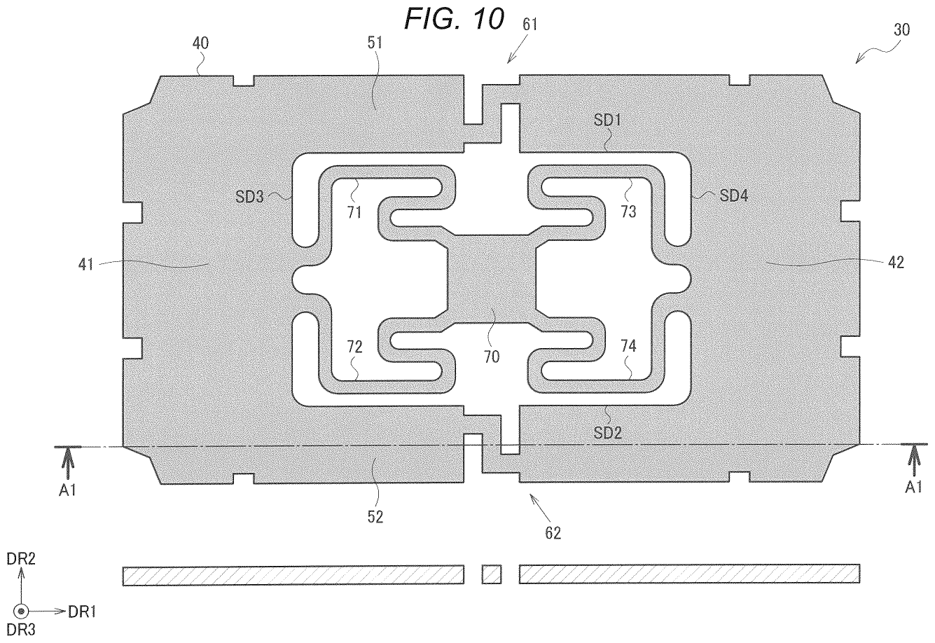

FIG. 10 shows an example in which spring portions are provided as the stress relaxation portions 61 and 62. Like the beam portions 71 to 74, the spring portions in FIG. 10 have shapes that are easily elastically deformed, for example, in the directions DR1 and DR2 as the in-plane directions. The spring portions are elastically deformed, and thereby, the stress acting on each part of the support substrate 30 due to the difference in thermal expansion coefficient can be further reduced. Further, the spring portions as the stress relaxation portions 61 and 62 have advantages in simplification of the manufacturing process, reduction of the manufacturing cost, and the like because, for example, the half etching process necessary for forming the slits as the stress relaxation portions 61 and 62 is not required.

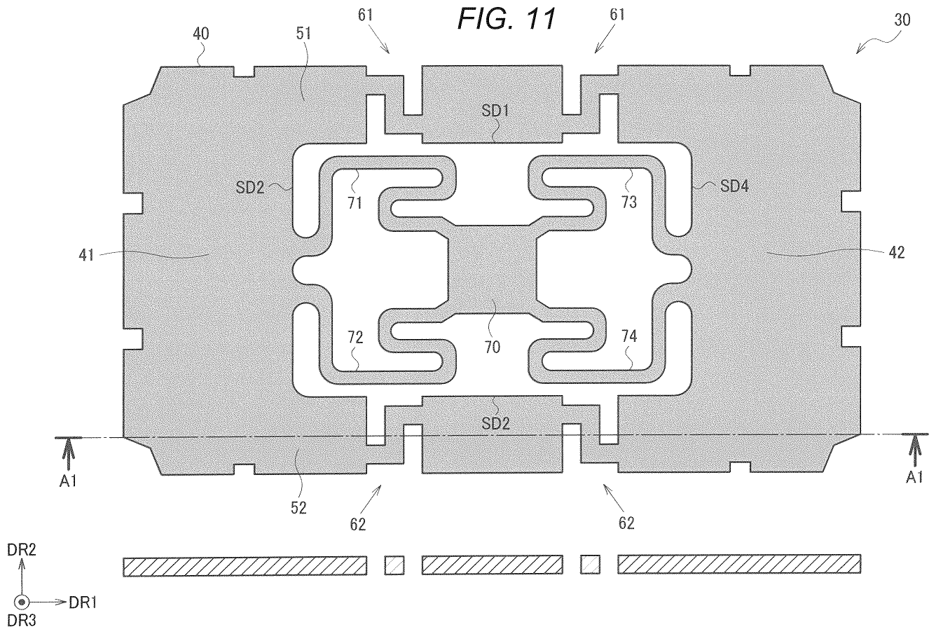

FIG. 11 shows an example in which a plurality of spring portions are provided as the stress relaxation portions 62 and 62. For example, in FIG. 11, a plurality of spring portions are provided along the direction DR1 as the long side direction of the support substrate 30. As described, when a plurality of spring portions are provided in each of the coupling parts of the coupling portions 51 and 52 as the stress relaxation portions 61 and 62, and thereby, the support substrate 30 is more easily deformed when stress acts thereon as compared with a case where one spring portion is provided in each coupling part as shown in FIG. 10. Accordingly, stress acting on each part of the support substrate 30 can be further reduced and relaxed as compared with that in FIG. 10.

As described above, the vibrator device 1 of the embodiment includes the vibration element 10, the support substrate 30 that supports the vibration element 10, and the base 2 to which the support substrate 30 is attached as shown in FIGS. 1, 3, and 4. Further, the support substrate 30 includes the frame portion 40, the element mounting portion 70 that is provided inside the frame portion 40 and on which the vibration element 10 is mounted, and the plurality of beam portions 71 to 74 that support the element mounting portion 70 inside the frame portion 40. As described above with reference to FIGS. 5 and 7 to 11, the frame portion 40 includes the stress relaxation portions 61 and 62 as the thin portions, the narrow portions, or the spring portions.

In the embodiment, the support substrate 30 has the frame portion 40, the element mounting portion 70 is provided inside the frame portion 40, and the plurality of beam portions 71 to 74 support the element mounting portion 70 inside the frame portion 40. According to the support substrate 30 having the above described configuration, since the frame portion 40 is provided, the rigidity in the parts of the beam portions 71 to 74 can be ensured. Accordingly, occurrence of a failure due to excessive stress on the beam portions 71 to 74 can be suppressed and handling at mounting is easier. Further, the frame portion 40 functions as a barrier and can protect the devices including the circuit device 20 below.

In the embodiment, the frame portion 40 is provided with the stress relaxation portions 61 and 62 as the thin portions, the narrow portions, or the spring portions. The stress relaxation portions 61 and 62 are provided, and thereby, even when stress is generated in the support substrate 30, stress acting on the respective parts of the support substrate 30 can be relaxed by deformation or the like of the support substrate 30 in the parts of the stress relaxation portions 61 and 62. As a result, occurrence of a failure caused by the stress generated in the support substrate 30 can be suppressed.

As shown in FIGS. 3 to 5 and 7 to 11, the frame portion 40 includes the supporting portion 41 as the first supporting portion attached to the base 2, the supporting portion 42 attached to the base 2 as the second supporting portion facing the supporting portion 41, and coupling portions 51 and 52 that couple the supporting portion 41 and the supporting portion 42. The stress relaxation portions 61 and 62 are provided in the coupling portions 51 and 52.

As described above, the supporting portion 41 and the supporting portion 42 are coupled by the coupling portions 51 and 52, and thereby, the rigidity of the support substrate 30 can be further increased. The stress relaxation portions 61 and 62 are provided in the coupling portions 51 and 52 provided to increase the rigidity, and thereby, the stress in the direction along the coupling portions 51 and 52 can be effectively relaxed.

Further, when the directions orthogonal to each other are the direction DR1 and the direction DR2, the support substrate 30 is a substrate having the long side in the direction DR1 as the first direction and the short side in the direction DR2 as the second direction, and the coupling portions 51 and 52 are members extending along the direction DR1. For example, the stress generated due to the difference in thermal expansion coefficient or the like acts more greatly along the long side direction than the short side direction of the support substrate 30.

Accordingly, the stress relaxation portions 61 and 62 are provided in the coupling parts 51 and 52 extending along the direction DR1 as the long side direction, and thereby, the stress in the long side direction can be effectively relaxed.

Further, in the embodiment, the coupling portion 51 and the coupling portion 52 that couple the supporting portion 41 and the supporting portion 42 are provided as the coupling portions, and the stress relaxation portion 61 disposed in the coupling portion 51 and the stress relaxation portion 62 disposed in the coupling portion 52 are provided as the stress relaxation portions. The supporting portions 41 and 42 are the first supporting portion and the second supporting portion, respectively, the coupling portions 51 and 52 are the first coupling portion and the second coupling portion, respectively, and the stress relaxation portions 61 and 62 are the first stress relaxation portion and the second stress relaxation portion, respectively.

As described above, the stress relaxation portion 61 is provided in the coupling portion 51 coupling the supporting portion 41 and the supporting portion 42, and thereby, the stress in the direction along the coupling portion 51 can be effectively relaxed. Further, the stress relaxation portion 62 is provided in the coupling portion 52 coupling the supporting portion 41 and the supporting portion 42, and thereby, the stress in the direction along the coupling portion 52 can be effectively relaxed. For example, the stress generated due to the difference in thermal expansion coefficient between the base 2 and the support substrate 30 acts, with the bonding members B1 at the supporting portion 41 side and the bonding members B1 at the supporting portion 42 side in FIG. 4 as fixed points, for example, as stress that pulls the support substrate 30 toward both sides along the direction DR1. The farther from the positions of the bonding members B1 as the fixed points, the higher the stress. Accordingly, the stress relaxation portion 61 is provided in the coupling portion 51 along the direction DR1, the stress relaxation portion 62 is provided in the coupling portion 52 along the direction DR1, and the support substrate 30 is deformed in a position away from the fixed points, and thereby, the stress due to the difference in thermal expansion coefficient can be effectively relaxed.

When the directions orthogonal to each other are the direction DR1 and the direction DR2, as shown in FIGS. 3 to 5 and 7 to 11, the frame portion 40 has the inner periphery SD1 and the inner periphery SD2 along the direction DR1 and the inner periphery SD3 and the inner periphery SD4 along the direction DR2. The inner peripheries SD1, SD2, SD3, and SD4 are the first inner periphery, the second inner periphery, the third inner periphery, or the fourth inner periphery, respectively. As the plurality of beam portions, the beam portions 71 and 72 extending from the inner periphery SD3 of the frame portion 40 and the beam portions 73 and 74 extending from the inner periphery SD4 of the frame portion 40 are provided. The beam portions 71 and 72 are the first beam portions, and the beam portions 73 and 74 are the second beam portions.

The beam portions 71, 72, 73, and 74 are provided, and thereby, even when stress along the direction DR1 is generated due to, for example, a difference in thermal expansion coefficient, stress acting on the support substrate 30 can be relaxed by elastic deformation of the beam portions 71 to 74. For example, in FIG. 4, the stress generated between the bonding member B1 for GND and the bonding member B1 for S1 at the upside can be relaxed by the stress relaxing portion 61, and the stress generated between the bonding member B1 for GND and the bonding member B1 for S2 at the downside can be relaxed by the stress relaxing portion 62. The stress generated between the bonding member B1 for DS and the bonding member B2 for DG in the middle can be relaxed by the elastic deformation of the beam portions 71 to 74.

In the embodiment, the two beam portions 71 and 72 are provided as the first beam portions, and the two beam portions 73 and 74 are provided as the second beam portions, however, the respective numbers of the first beam portions and the second beam portions may be one, three, or more.

In the embodiment, as the stress relaxation portions, the stress relaxation portion 61 disposed along the direction DR2 from the inner periphery SD1 and the stress relaxation portion 62 disposed along the direction DR2 from the inner periphery SD2 are provided. With the slits in FIGS. 5, 7, and 8 as examples, the slit of the stress relaxation portion 61 is a slit having a shape extending upward along the direction DR2 from the inner periphery SD1. The slit of the stress relaxation portion 62 is a slit having a shape extending downward in the direction DR2 from the inner periphery SD2.

According to the configuration, the stress generated along the direction DR1 due to the difference in thermal expansion coefficient or the like can be relaxed by the stress relaxation portions 61 and 62 disposed along the direction DR2 orthogonal to the direction DR1. For example, the stress relaxation portions 61 and 62 disposed along the direction DR2 are deformed around an axis in the direction DR2, and thereby, the stress generated along the direction DR1 can be effectively relaxed. Note that, for example, the stress relaxation portions 61 and 62 may be arranged along the direction DR1 as shown in FIG. 9, or may have parts along the direction DR2 and parts along the direction DR1 as shown in FIGS. 10 and 11.

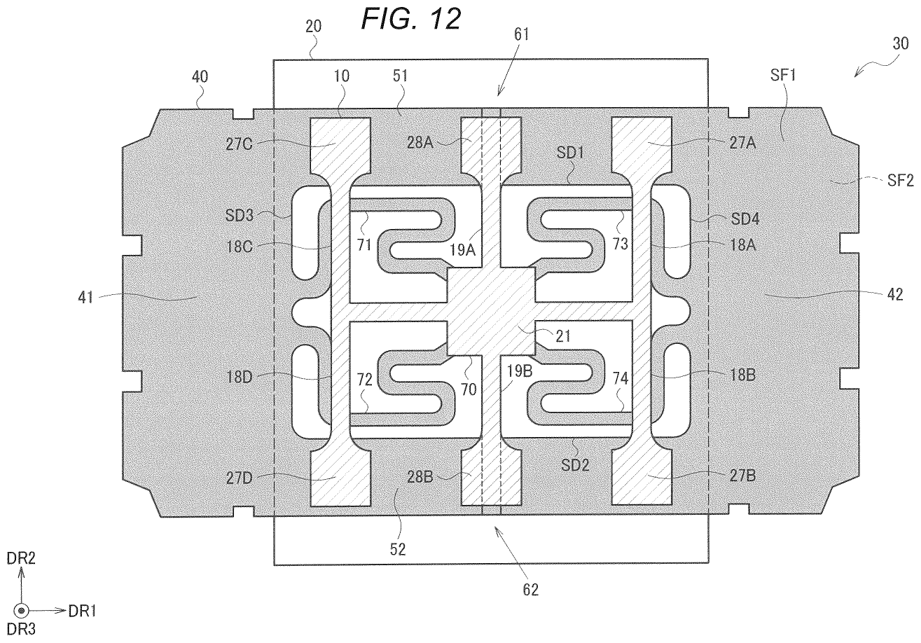

Next, an arrangement relationship among the support substrate 30, the vibration element 10, and the circuit device 20, and an arrangement relationship among the bonding members B1 and the stress relaxation portions 61 and 62 will be described. FIG. 12 shows an example of the arrangement relationship among the support substrate 30, the vibration element 10, and the circuit device 20.

As shown in FIG. 12, the vibration element 10 is disposed at the surface SF1 side of the support substrate 30. The circuit device 20 is disposed at the surface SF2 side of the support substrate 30. That is, the support substrate 30 is disposed between the vibration element 10 and the circuit device 20. As described with reference to FIG. 2, the vibrator device 1 includes the circuit device 20 having the drive circuit 100 that drives the vibration element 10. The vibration element 10 includes the weight portions 27A, 27B, 27C, 27D as balance adjustment portions. As shown in FIG. 12, in the plan view, the weight portions 27A, 27B, 27C, 27D as the balance adjustment portions, the coupling portions 51, 52 of the support substrate 30, and the circuit device 20 overlap. For example, the coupling portions 51 and 52 of the support substrate 30 are positioned below the weight portions 27A to 27D of the vibration element and the circuit device 20 is positioned below the coupling portions 51 and 52. According to the configuration, at the time of balance adjustment of the vibration element 10, the coupling portions 51 and 52 of the support substrate 30 can be effectively used as the protection members for the circuit device 20.

For example, as described above with reference to FIG. 2, for the balance adjustment of the vibration of the vibration element 10, the metals of the weight portions 27A to 27D are trimmed by the laser. This balance adjustment is performed with the circuit device 20, the support substrate 30, and the vibration element 10 mounted on the package 4 in the manufacturing process of the vibrator device 1. Accordingly, a situation in which the laser for balance adjustment is applied to the circuit device 20 below the weight portions 27A to 27D may occur.

In this regard, in the embodiment, as shown in FIG. 12, the weight portions 27A to 27D as the balance adjustment portions, the coupling portions 51 and 52 of the support substrate 30, and the circuit device 20 overlap in the plan view in the direction DR3. According to the configuration, the coupling portions 51 and 52 serve as barriers at the time of balance adjustment, prevent application of the laser to the circuit device 20, and can protect the circuit device 20.

The vibration element 10 is, for example, the double-T-shaped gyro sensor element as described with reference to FIG. 2. As shown in FIG. 12, the stress relaxation portions 61 and 62 of the support substrate 30 are provided below the weight portions 28A and 28B of the detection arms 19A and 19B of the double-T-shaped gyro sensor element. According to the configuration, when the balance adjustment such that the metals of the weight portions 27A to 27D of the drive arms 18A to 18D of the double-T-shaped gyro sensor element are trimmed is performed, occurrence of a failure caused by the balance adjustment can be suppressed.

For example, the positions below the weight portions 27A to 27D of the drive arms 18A to 18D may be assumed as the arrangement positions of the stress relaxation portions 61 and 62. However, when the positions are below the weight portions 27A to 27D used for the balance adjustment, the laser at the time of the balance adjustment may be applied to the stress relaxation portions 61 and 62 and a failure may occur. Accordingly, it is not preferable that the laser for balance adjustment is applied to the stress relaxation portions 61 and 62 as the thin portions or the like. In this regard, since the weight portions 28A and 28B of the detection arms 19A and 19B are not used for balance adjustment, any problem may occur when the stress relaxation portions 61 and 62 are disposed below the weight portions 28A and 28B.

The widths of the weight portions 28A and 28B of the detection arms 19A and 19B in the direction DR1 are, for example, about 400 μm to 500 μm, and the widths of the weight portions 27A to 27D of the drive arms 18A to 18D in the direction DR1 are, for example, about 200 μm to 300 μm. The widths of the slits as the stress relaxation portions 61 and 62 in the direction DR1 can be set to, for example, about 100 μm to 200 μm.

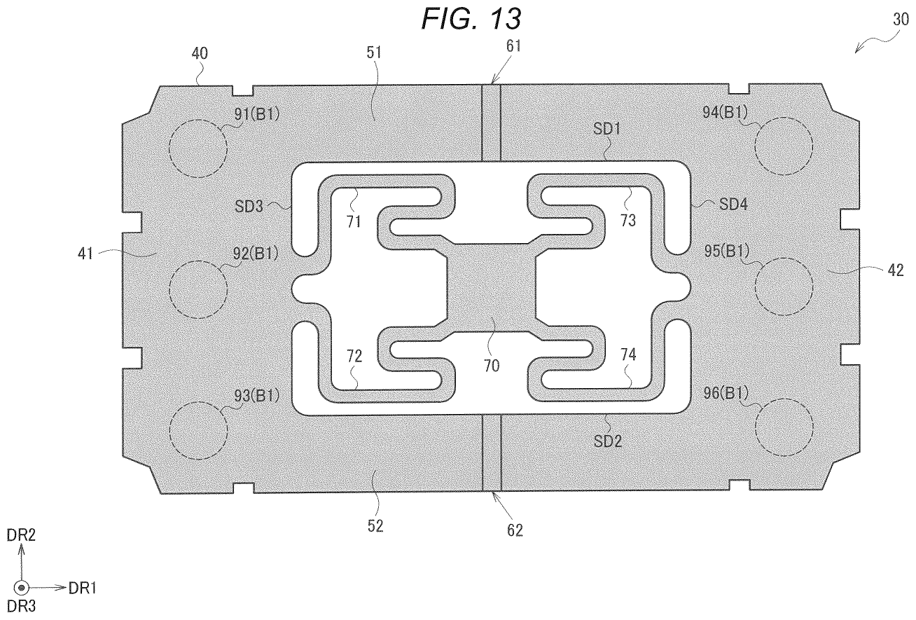

FIG. 13 shows an example of an arrangement relationship between the bonding members B1 for substrate and the stress relaxation portions 61 and 62. For example, as described above with reference to FIGS. 1 to 4, the vibrator device 1 of the embodiment includes the bonding members B2 for element that bond the element mounting portion 70 of the support substrate 30 and the base portion 21 of the vibration element 10, and the bonding members B1 for substrate that bond the support substrate 30 and the base 2. As an example, the bonding members B2 for element are realized by metal bumps or the like. The bonding members B1 for substrate are realized by, for example, conductive adhesives, and more specifically, realized by conductive thermosetting adhesives. According to the configuration, the element mounting portion 70 of the support substrate 30 and the base portion 21 of the vibration element 10 are bonded by the bonding members B2 for element, and thereby, the vibration element 10 can be mounted and attached onto the support substrate 30. Further, the support substrate 30 and the base 2 are bonded by the bonding members B1 for substrate, and thereby, the support substrate 30 with the vibration element 10 attached thereon can be attached to the base 2.

In FIG. 13, as the bonding members B1 for substrate, first substrate bonding members 91, 92, and 93 and second substrate bonding members 94, 95, and 96 are provided. The second substrate bonding members 94, 95, 96 are disposed with respect to the first substrate bonding members 91, 92, 93 with the element mounting unit 70 in between. For example, the first substrate bonding members 91, 92, and 93 are disposed below the supporting portion 41 of the support substrate 30, and the second substrate bonding members 94, 95, and 96 are disposed below the supporting portion 42 of the support substrate 30. Below is, for example, the opposite direction side to the direction DR3. Specifically, in FIG. 13, the first substrate bonding members 91, 92, and 93 are formed on the internal terminal 6A of the first step portion at the left side of the recess 9A of the base 2, and the second substrate bonding members 94, 95, and 96 are formed on the internal terminal 6B of the second step portion at the right side of the recess 9A of the base 2.

The stress relaxation portions 61 and 62 are provided between the first substrate bonding members and the second substrate bonding members. For example, in FIG. 13, the stress relaxation portion 61 is disposed between the first substrate bonding member 91 and the second substrate bonding member 94. The stress relaxation portion 62 is disposed between the first substrate bonding member 93 and the second substrate bonding member 96.

For example, the stress due to the difference in thermal expansion coefficient between the base 2 and the support substrate 30 is generated, with the first substrate bonding members 91, 92, and 93 and the second substrate bonding members 94, 95, and 96 as fixed points, as stress along the direction of DR1 pulling the support substrate 30 inwardly. The farther from the fixed points, the higher the stress. Accordingly, the stress relaxation portion 61 is disposed between the first substrate bonding member 91 and the second substrate bonding member 94 and the stress relaxation portion 62 is disposed between the first substrate bonding member 93 and the second substrate bonding member 96, and thereby, the stress in the parts farther from the fixed points can be effectively relaxed. Therefore, concentration of stress in the other parts of the support substrate 30 due to deformation or the like in the parts of the stress relaxation portions 61 and 62 far from the fixed points can be effectively suppressed.

The frame portion 40 includes the supporting portion 41 attached to the base 2, the supporting portion 42 attached to the base 2 and facing the supporting portion 41, and the coupling portions 51 and 52 coupling the supporting portion 41 and the supporting portion 42. The supporting portion 41 is bonded to the base 2 by the first substrate bonding members 91, 92, and 93, and the supporting portion 42 is bonded to the base 2 by the second substrate bonding members 94, 95, and 96.

According to the configuration, the supporting portion 41 is joined to the base 2 by the first substrate members 91, 92, and 93, and the supporting portion 42 is joined to the base 2 by the second substrate members 94, 95, and 96, and thereby, the support substrate 30 can be attached to the base 2. The supporting portion 41 and the supporting portion 42 are coupled by the coupling portions 51 and 52, and thereby, the rigidity of the support substrate 30 attached to the base 2 can be increased. As a result, for example, even when stress due to the difference in thermal expansion coefficient between the base 2 and the support substrate 30 is generated, the rigidity in the parts of the beam portions 71 to 74 and the like can be ensured.

The bonding member B1 for substrate is, for example, a thermosetting adhesive. For example, the first substrate bonding members 91, 92, and 93 and the second substrate bonding members 94, 95, and 96 in FIG. 13 are realized by thermosetting adhesives. With the thermosetting adhesives, the support substrate 30 and the base 2 can be bonded only by positioning and heating of the support substrate 30 on the base 2 using the bonding members B1 for substrate as the thermosetting adhesives. Then, even in a case where stress due to the difference in thermal expansion coefficient between the base 2 and the support substrate 30 is generated when the substrate returns from the high temperature to the normal temperature after the thermal curing, the stress can be effectively relaxed by the stress relaxation portions 61 and 62.

For example, as the bonding member B1 for substrate, a conductive thermosetting adhesive in which conductive fillers such as silver fillers are dispersed in a thermosetting adhesive can be used. For example, a thermosetting adhesive called silver paste is applied to the internal terminal 6A of the first step portion and the internal terminal 6B of the second step portion of the recess 9A of the base 2 in FIG. 1. Then, the support substrate 30 is disposed so that the terminals TDS and TGND of the supporting portion 41 in FIG. 4 and the terminals TS1, TDG, and TS2 of the supporting portion 42 are located in the positions of the bonding members B1 for DS, GND, S1, DG, and S2. Then, the vibrator device 1 is heated in a furnace to cure the thermosetting adhesive, and thereby, the support substrate 30 is attached to the base 2. In this case, stress corresponding to the difference in thermal expansion coefficient is generated, however, in the embodiment, the stress relaxation portions 61 and 62 are provided and can relax the stress.

As shown in FIGS. 1, 3, and 4, the support substrate 30 has the surface SF1 as the first surface and the surface SF2 as the second surface opposite to the surface SF1, and the vibration element 10 is supported at the surface SF1 side of the support substrate 30. As shown in FIG. 3, the metal film 43 that covers at least the stress relaxation portions 61 and 62 is provided at the surface SF1 side of the support substrate 30. For example, in FIG. 3, the metal film 43 set at the GND potential is formed on the surface SF1 of the support substrate 30. As shown in FIG. 4, the metal film 43 set at the GND potential is also formed on the surface SF2 of the support substrate 30. The metal film 43 serves as a shield for GND of the support substrate 30.

As shown in FIG. 3, the metal film 43 is provided on the surface SF1 to cover the stress relaxation portions 61 and 62. According to the configuration, the metal film 43 can be used as a protective film for the stress relaxation portions 61 and 62 and a protective film for devices disposed in positions overlapping with the stress relaxation portions 61 and 62.

For example, in the balance adjustment of the vibration element 10 described with reference to FIGS. 2 and 12, the metals of the weight portions 27A to 27D are trimmed by the laser. In this case, it is not preferable that the laser is applied to the stress relaxation portions 61 and 62 as the thin portions or the narrow portions and the circuit device 20 disposed below the stress relaxation portions 61 and 62.

In this regard, in FIG. 3, the metal film 43 covering the stress relaxation portions 61 and 62 is provided at the surface SF1 side or the like of the support substrate 30. According to the configuration, the metal film 43 serves as a protective film and the stress relaxation portions 61 and 62 and the circuit device 20 can be protected.

In the embodiment, the support substrate 30 and the vibration element 10 are formed using quartz crystal substrates. As described above, the support substrate 30 is formed using a quartz crystal substrate like the vibration element 10, and thereby, the fluctuations of the resonance frequency of the support substrate 30 due to temperature changes can be reduced. According to the configuration, superimposition of the resonance frequency of the support substrate 30 on the vibration frequency (drive frequency) of the vibration element 10 can be easily avoided. As a result, deterioration of detection accuracy and the like due to generation of unnecessary vibration in the vibration element 10 can be effectively suppressed. In addition, the support substrate 30 and the vibration element 10 are formed using the same quartz crystal substrates, and thereby, occurrence of a failure caused by the difference in thermal expansion coefficient can be effectively prevented.

As described above, the vibrator device of the embodiment includes the vibration element, the support substrate supporting the vibration element, and the base to which the support substrate is attached. The support substrate includes the frame portion, the element mounting portion that is provided inside the frame portion and on which the vibration element is mounted, and the plurality of beam portions that support the element mounting portion inside the frame portion. The frame portion includes the stress relaxation portion as the thin portion, the narrow portion, or the spring portion.

As described above, in the embodiment, since the support substrate has the frame portion, and the element mounting portion is supported by the plurality of beam portions inside the frame portion, the rigidity in the parts of the beam portions can be ensured. In the embodiment, the frame portion is provided with the stress relaxation portion as the thin portion, the narrow portion, or the spring portion. The stress relaxation portion is provided, and thereby, even when stress is generated in the support substrate, stress acting on the respective parts of the support substrate can be relaxed and occurrence of a failure caused by the stress generated in the support substrate can be suppressed.

In the embodiment, the frame portion may include the first supporting portion attached to the base, the second supporting portion attached to the base and facing the first supporting portion, and the coupling portion coupling the first supporting portion and the second supporting portion, and the stress relaxation portion may be provided in the coupling portion.

As described above, the first supporting portion and the second supporting portion are coupled by the coupling portion, and thereby, the rigidity of the support substrate can be increased. Further, as described above, the stress relaxation portion is provided in the coupling portion provided to increase the rigidity, the stress in the direction along the coupling portion can be effectively relaxed.

In the embodiment, the circuit device having the drive circuit that drives the vibration element may be provided, the vibration element may have the balance adjustment portion, and the balance adjustment portion, the coupling portion, and the circuit device may overlap in the plan view.

According to the configuration, at the time of balance adjustment of the vibration element, the coupling portion of the support substrate can be effectively used as the protection member for the circuit device.

Further, in the embodiment, when the directions orthogonal to each other are the first direction and the second direction, the support substrate may be the substrate having the long side in the first direction and the short side in the second direction, and the coupling portion may be a member extending along the first direction.

As described above, the stress relaxation portion is provided in the coupling portion extending in the first direction as the long side direction, and thereby, the stress in the long side direction can be effectively relaxed.

In the embodiment, as the coupling portions, the first coupling portion and the second coupling portion that couple the first supporting portion and the second supporting portion may be provided, and, as the stress relaxation portions, the first stress relaxation portion disposed in the first coupling portion and the second stress relaxation portion disposed in the second coupling portion may be provided.

As described above, the first stress relaxation portion is provided in the first coupling portion coupling the first supporting portion and the second supporting portion, and thereby, the stress in the direction along the first coupling portion can be effectively relaxed. Further, the second stress relaxation portion is provided in the second coupling portion coupling the first supporting portion and the second supporting portion, and thereby, the stress in the direction along the second coupling portion can be effectively relaxed.

In the embodiment, the vibration element may be the double-T-shaped gyro sensor element, and the stress relaxation portion may be provided below the weight portion of the detection arm of the double-T-shaped gyro sensor element.

According to the configuration, when the balance adjustment using the weight portion of the drive arm of the double-T-shaped gyro sensor element is performed, occurrence of a failure caused by the balance adjustment can be suppressed.

In the embodiment, when the directions orthogonal to each other are the first direction and the second direction, the frame portion may have the first inner periphery and the second inner periphery along the first direction, the third inner periphery and the fourth inner periphery along the second direction, and the first beam portion extending from the third inner periphery of the frame portion and the second beam portion extending from the fourth inner periphery of the frame portion may be provided as the plurality of beam portions.

The first beam portion and the second beam portion are provided, and thereby, even when stress along the first direction is generated in the support substrate, the stress acting on the support substrate can be relaxed by elastic deformation of the first beam portion and the second beam portion.

In the embodiment, as the stress relaxation portions, the first stress relaxation portion disposed along the second direction from the first inner periphery and the second stress relaxation portion disposed along the second direction from the second inner periphery may be provided.

According to the configuration, for example, the stress generated along the first direction in the support substrate can be relaxed by the first stress relaxation portion and the second stress relaxation portion disposed along the second direction orthogonal to the first direction.

In the embodiment, the element bonding member that bonds the element mounting portion of the support substrate and the base portion of the vibration element and the substrate bonding member that bonds the support substrate and the base may be provided.

According to the configuration, the element mounting portion of the support substrate and the base portion of the vibration element are bonded by the bonding member for element, and thereby, the vibration element can be attached to the support substrate. The support substrate and the base are bonded by the substrate bonding member, and thereby, the support substrate to which the vibration element is attached can be attached to the base.

In the embodiment, the first substrate bonding member and the second substrate bonding member disposed with respect to the first substrate bonding member with the element mounting portion in between may be provided as the substrate bonding members, and the stress relaxation portion may be provided between the first substrate bonding member and the second substrate bonding member.

According to the configuration, even when stress is generated in the support substrate with the first substrate bonding member and the second substrate bonding member as the fixed points, stress in a part farther from the fixed points can be effectively relaxed by the first stress relaxation portion and the second stress relaxation portion, and concentration of stress in the other parts of the support substrate can be effectively suppressed.

In the embodiment, the frame portion may include the first supporting portion attached to the base, the second supporting portion attached to the base and facing the first supporting portion, and the coupling portion coupling the first supporting portion and the second supporting portion. The first supporting portion may be bonded to the base by the first substrate bonding member, and the second supporting portion may be bonded to the base by the second substrate bonding member.

According to the configuration, the first supporting portion is bonded to the base by the first substrate bonding member and the second support unit is bonded to the base by the second substrate bonding member, and thereby, the support substrate can be attached to the base. The first supporting portion and the second supporting portion are coupled by the coupling portion, and thereby, the rigidity of the support substrate attached to the base can be increased.

In the embodiment, the substrate bonding member may be the thermosetting adhesive.

With the thermosetting adhesive, the support substrate and the base can be bonded only by positioning and heating of the support substrate on the base using the thermosetting adhesive.

In the embodiment, the support substrate may include the first surface and the second surface opposite to the first surface, the vibration element may be supported at the first surface side of the support substrate, and the metal film that covers at least the stress relaxation portion may be provided at the first surface side of the support substrate.

According to the configuration, the metal film can be used as the protective film for the stress relaxation portion and the protective film for devices disposed in positions overlapping with the stress relaxation portion in the plan view.

In the embodiment, the support substrate and the vibration element quartz crystal substrates.

As described above, the support substrate is formed using the quartz crystal substrate like the vibration element, and thereby, the fluctuations of the resonance frequency of the support substrate due to temperature changes can be reduced and generation of unnecessary vibration in the vibration element can be effectively prevented.

While the embodiment has been described in detail above, a person skilled in the art can readily understand that many modifications can be made without substantially departing from the novel matters and effects of the present disclosure. Therefore, all such modifications are within the scope of the present disclosure. For example, a term described at least once together with a different term having a broader meaning or the same meaning in the description or the drawings can be replaced with the different term at any place in the description or the drawings. The configurations of the vibrator device, the support substrate, the vibration element, and the circuit device are not limited to those described in the embodiment, and various modifications can be made.

What is claimed is:

1. A vibrator device comprising:
a vibration element;
a support substrate supporting the vibration element; and
a base to which the support substrate is attached, wherein
the support substrate includes a frame portion, an element mounting portion provided inside the frame portion, on which the vibration element is mounted, and a plurality of beam portions supporting the element mounting portion inside the frame portion, and
the frame portion includes a stress relaxation portion as a thin portion, a narrow portion, or a spring portion.

2. The vibrator device according to claim 1, wherein
the frame portion includes a first supporting portion attached to the base, a second supporting portion attached to the base and facing the first supporting portion, and a coupling portion coupling the first supporting portion and the second supporting portion, and
the stress: relaxation portion is provided in the coupling portion.

3. The vibrator device according to claim 2, further comprising a circuit device having a drive circuit for driving the vibration element, wherein
the vibration element has a balance adjustment portion, and
the balance adjustment portion, the coupling portion, and the circuit device overlap in a plan view.

4. The vibrator device according to claim 2, wherein
when directions orthogonal to each other are a first direction and a second direction, the support substrate is a substrate having a long side in the first direction and a short side in the second direction, and the coupling portion is a member extending along the first direction.

5. The vibrator device according to claim 2, wherein
as the coupling portions, a first coupling portion and a second coupling portion that couple the first supporting portion and the second supporting portion are provided, and
as the stress relaxation portions, a first stress relaxation portion disposed in the first coupling portion and a second stress relaxation portion disposed in the second coupling portion are provided.

6. The vibrator device according to claim 1, wherein
the vibration element is a double-T-shaped gyro sensor element, and
the stress relaxation portion is provided below a weight portion of a detection arm of the double-T-shaped gyro sensor element.

7. The vibrator device according to claim 1, wherein
when directions orthogonal to each other are a first direction and a second direction, the frame portion has a first inner periphery and a second inner periphery along the first direction and a third inner periphery and a fourth inner periphery along the second direction, and
as the plurality of beam portions, a first beam portion extending from the third inner periphery of the frame portion and a second beam portion extending from the fourth inner periphery of the frame portion are provided.

8. The vibrator device according to claim 7, wherein
as the stress relaxation portions, a first stress relaxation portion disposed along the second direction from the first inner periphery and a second stress relaxation portion disposed along the second direction from the second inner periphery are provided.

9. The vibrator device according to claim 1, further comprising:
an element bonding member bonding the element mounting portion of the support substrate and a base portion of the vibration element; and
a substrate bonding member bonding the support substrate and the base.

10. The vibrator device according to claim 9, wherein
as the substrate bonding members, a first substrate bonding member and a second substrate bonding member disposed with respect to the first substrate bonding member with the element mounting portion in between are provided, and
the stress relaxation portion is provided between the first substrate bonding member and the second substrate bonding member.

11. The vibrator device according to claim 10, wherein
the frame portion includes:
a first supporting portion attached to the base;
a second supporting portion attached to the base and facing the first supporting portion; and
a coupling portion coupling the first supporting portion and the second supporting portion,
the first supporting portion is bonded to the base by the first substrate bonding member, and
the second supporting portion is bonded to the base by the second substrate bonding member.

12. The vibrator device according to claim 9, wherein
the substrate bonding member is a thermosetting adhesive.

13. The vibrator device according to claim 1, wherein
the support substrate has a first surface and a second surface opposite to the first surface,
the vibration element is supported at the first surface side of the support substrate, and
a metal film that covers at least the stress relaxation portion is provided at the first surface side of the support substrate.

14. The vibrator device according to claim 1, wherein
the support substrate and the vibration element are formed using quartz crystal substrates.
